(19) United States
(12) Patent Application Publication
(10) Pub. No.: US 2019/0108431 A1
(43) Pub. Date: Apr. 11, 2019

(54) ELECTRONIC CARD

(71) Applicant: HONDA MOTOR CO., LTD., Tokyo (JP)

(72) Inventor: Seonghun Lee, Wako-shi (JP)

(21) Appl. No.: 16/149,165

(22) Filed: Oct. 2, 2018

(30) Foreign Application Priority Data
Oct. 11, 2017 (JP) 2017-197862

(51) Int. Cl. G06K 19/07

(52) U.S. Cl. CPC G06K 19/0723

(57) ABSTRACT

Provided is an electronic card (1) including: a card casing (2) which is formed as a plate-like body, and in which a tapered surface (2At) having an inclination in which a thickness of a cross-section decreases toward an end surface of the plate-like body on one surface side of the plate-like body, and a step (2b) protruding from the tapered surface in a direction intersecting the tapered surface is formed; an electronic device incorporated in the card casing; and a sheet shaped part (3) in which a thickness of a cross section is formed to be thinner than a height of the step, and end surface abuts against a wall surface formed on the step, and which is fixed to the one surface side of the card casing including the tapered surface.

### CROSS-REFERENCE TO RELATED APPLICATION

Priority is claimed on Japanese Patent Application No. 2017-197862, filed Oct. 11, 2017, the content of which is incorporated herein by reference.

### BACKGROUND OF THE INVENTION

### Field of the Invention

The present invention relates to an electronic card.

### Description of Related Art

Since recent years, a card key in which a key for locking or unlocking a door of a vehicle, opening or closing the door, and the like is formed in a card shape has been known. In order to improve the design of the card key, a technique of sticking a sheet shaped part on which coloring, decoration or the like is performed on one side of a card key main body is known (for example, Japanese Unexamined Patent Application, First Publication No. 2012-36715).

### SUMMARY OF THE INVENTION

However, the related art did not consider the prevention of peeling of the sheet shaped part stuck to the card key or facilitation of the insertion or removal of the card key into and from an object to be accommodated.

The present invention has been made in consideration of such circumstances, and an object thereof is to provide an electronic card capable of preventing peeling of a sheet shaped part, making it easy to accommodate, and further improving design.

The electronic card according to the present invention employs the following configuration.

(1) An electronic card according to an aspect of the present invention is an electronic card including: a card casing which is formed as a plate-like body, and in which a tapered surface having an inclination in which a thickness of a cross-section decreases toward an end surface of the plate-like body on one surface side of the plate-like body, and a step protruding from the tapered surface in a direction intersecting the tapered surface is formed; an electronic device incorporated in the card casing; and a sheet shaped part in which a thickness of a cross section is formed to be thinner than a height of the step, and end surface abuts against a wall surface formed on the step, and which is fixed to the one surface side of the card casing including the tapered surface.

(2) In the aspect of the above (1), the step may be formed to protrude in a direction of a normal line of the tapered surface.

(3) In the aspect of the above (1), the card casing may be a card key. According to the above aspect (1), it is possible to prevent peeling of the sheet shaped part by the step, to make it easier to accommodate by the tapered surface, and to further improve design.

According to the aspect (2), in a case that accommodating the electronic card in a pocket of a wallet or the like, a force in a direction in which the sheet shaped part is peeled off from the card casing is not applied to the sheet shaped part, and peeling of the sheet shaped part can be prevented.

According to the above aspect (3), an occupant of the vehicle can carry the key by accommodating the key in a wallet or the like.

### BRIEF DESCRIPTION OF THE DRAWINGS

FIG. 1 is a plan view illustrating an example of a configuration of an electronic card.

FIG. 2 is a cross-sectional view of the electronic card.

FIG. 3 is a diagram illustrating an example of a state of accommodating the electronic card.

FIG. 4 is a diagram illustrating a state of a force applied to a sheet shaped part.

FIG. 5 is a diagram illustrating an example of a state of extracting the electronic card.

FIG. 6 is a cross-sectional view of an electronic card that is an object of comparison.

FIG. 7 is a cross-sectional view of an electronic card according that is another object of comparison.

FIG. 8 is a cross-sectional view of an electronic card according to a modified example.

### DETAILED DESCRIPTION OF THE INVENTION

Hereinafter, an embodiment of the electronic card of the present invention will be described with reference to the drawings.

### First Embodiment

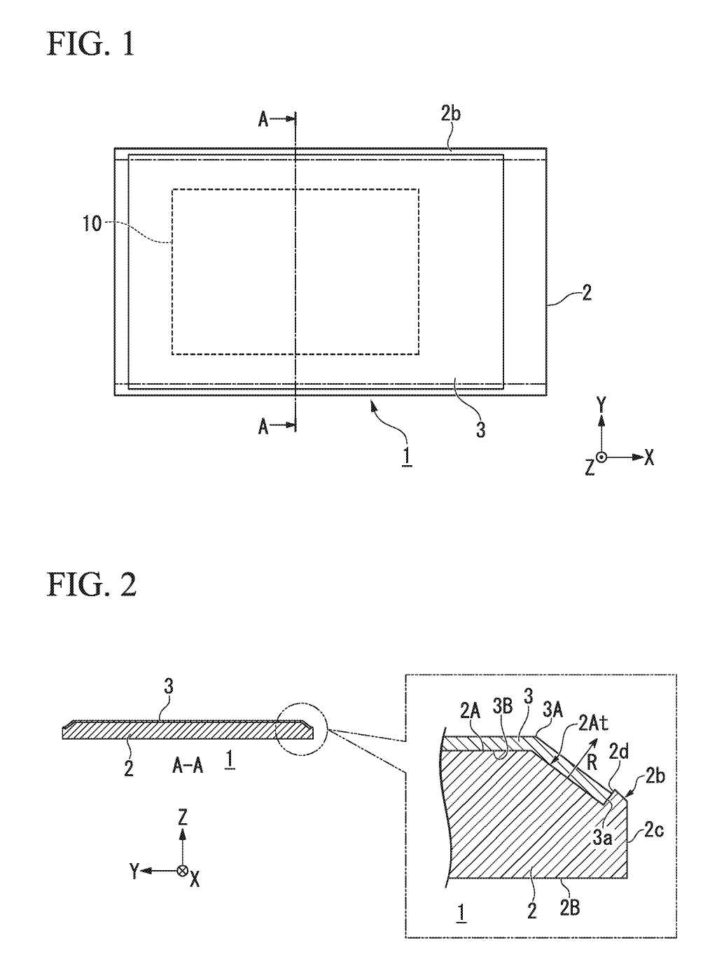

FIG. 1 is a plan view illustrating an example of the configuration of an electronic card 1 of the first embodiment. FIG. 2 is a cross-sectional view of the electronic card 1. The electronic card 1 includes, for example, a card casing 2 and a sheet shaped part 3. The electronic card 1 is used, for example, as a card key for performing locking or unlocking of a door of a vehicle, opening or closing of the door or the like.

An electronic device 10 used for opening and closing the door, a battery (not illustrated) for driving the electronic device and the like are housed inside the card casing 2. Specifically, the electronic device 10, for example, communicates with the vehicle to control the opening and closing of the door, or performs an authentication process such as an engine startup of the vehicle, turning on/off a vehicle power supply, and seat control. In order to accommodate the electronic device 10, the card casing 2 is formed to be freely divided into one surface 2A side and the other surface 2B side. A battery cover (not illustrated) is provided on the other surface 2B side of the card casing 2.

The card casing 2 is, for example, a rectangular plate-like body. The outer diameter size of the card casing 2 is formed to be equal to that of a credit card so that the card casing 2 can be accommodated in an accommodation target such as a wallet or a card holder.

In FIG. 2, a configuration in an A-A cross section in a short side direction (a Y-axis direction) of the rectangular electronic card 1 is illustrated. As illustrated in FIG. 2, for example, a tapered surface 2At is formed to extend along a long side of the card casing 2 on the one surface 2A side of the card casing 2. The tapered surface 2At has an inclination formed such that a thickness of the cross section decreases toward the end surface 2c of the card casing 2. That is, the cross section in the short side direction of the card casing 2 is formed in a trapezoidal shape.

On the long side of the tapered surface 2At, on the end surface 2c side, for example, a step 2b is formed to extend in the long side direction (an X-axis direction) of the card casing 2. For example, the step 2b is formed to protrude from the tapered surface 2At in a direction intersecting the tapered surface 2At. On the step 2b, a wall surface 2d erected in a direction of a normal line R of the tapered surface 2At extends on the tapered surface 2At in the long side direction.

The sheet shaped part 3 is, for example, a decorative sheet stuck to one surface side of the card casing 2. The sheet shaped part 3 is formed in a rectangular sheet shape, for example, with a synthetic resin material such as polycarbonate, polypropylene, polyethylene terephthalate, polystyrene, and vinyl chloride. The sheet shaped part 3 may be formed by pressing a thin metal plate or the like. On the front surface 3A side of the sheet shaped part 3, decoration and coloring are applied by printing, thermal transfer, molding or the like.

An area of the sheet shaped part 3 is formed to be slightly smaller than an area of the one surface 2A side of the card casing 2 including the tapered surface 2At. The thickness of the cross section of the sheet shaped part 3 is formed to be thinner than the height of the wall surface 2d of the step 2b. For example, an adhesive is applied to a back surface 3B side of the sheet shaped part 3, and the sheet shaped part 3 is affixed and fixed to the one surface 2A side of the card casing 2. At this time, the sheet shaped part 3 is elastically deformed and conforms to the shape of the one surface 2A side of the card casing 2 including the tapered surface 2At. The end surface 3a of the sheet shaped part 3 abuts along the wall surface 2d. Further, the sheet shaped part 3 is fixed to the one surface 2A side including the tapered surface 2At of the card casing 2.

FIG. 3 is a diagram illustrating an example of a state of accommodating the electronic card 1. The electronic card 1 is accommodated, for example, in a card pocket B1 of a wallet B. In a case that the electronic card 1 is accommodated, as the electronic card 1 moves into the pocket B1, a frictional force F from the pocket B1 is applied to the surface of the sheet shaped part 3.

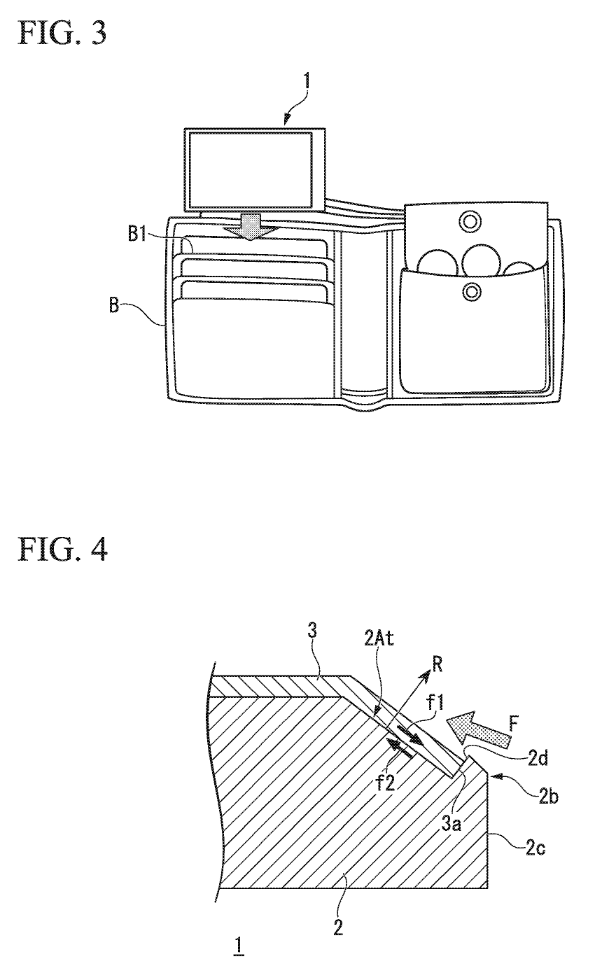

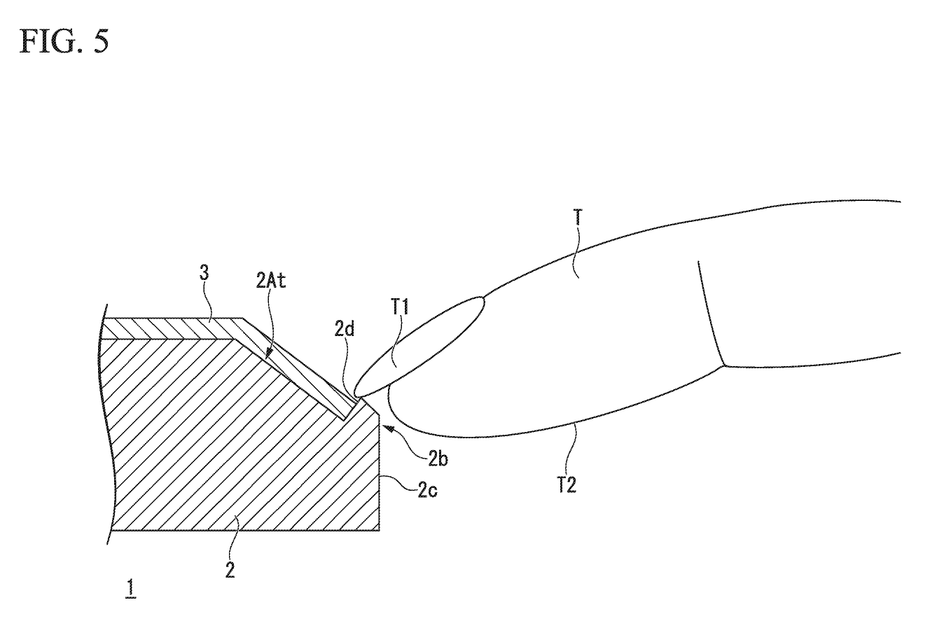

FIG. 4 is a diagram illustrating a state of force applied to the sheet shaped part 3. As illustrated in FIG. 4, in this state, the frictional force F generated from the pocket B1 is applied to the surface of the sheet shaped part 3 in a direction along the inclination of the tapered surface 2At. Further, the shear forces f1 and f2 that oppose each other in the direction of the inclination of the tapered surface 2At are generated in the sheet shaped part 3 and the card casing 2. Therefore, no force is generated in the sheet shaped part 3 in the direction of the normal line R in which the sheet shaped part 3 peels off. Then, since the adhesive force of the adhesive for bonding the sheet shaped part 3 and the tapered surface 2At can sufficiently resist the shearing forces f1 and f2, the sheet shaped part 3 is not easily peeled off of the tapered surface 2At.

Furthermore, since the height of the wall surface 2d of the step 2b is higher than the thickness of the sheet shaped part 3, the pocket B1 does not come into contact with the surface near the end surface 3a of the sheet shaped part 3. Therefore, the frictional force F generated from the pocket B1 is not applied to the vicinity of the end surface 3a of the sheet shaped part 3, and a force in a direction in which the sheet shaped part 3 is peeled off of the tapered surface 2At does not easily occur.

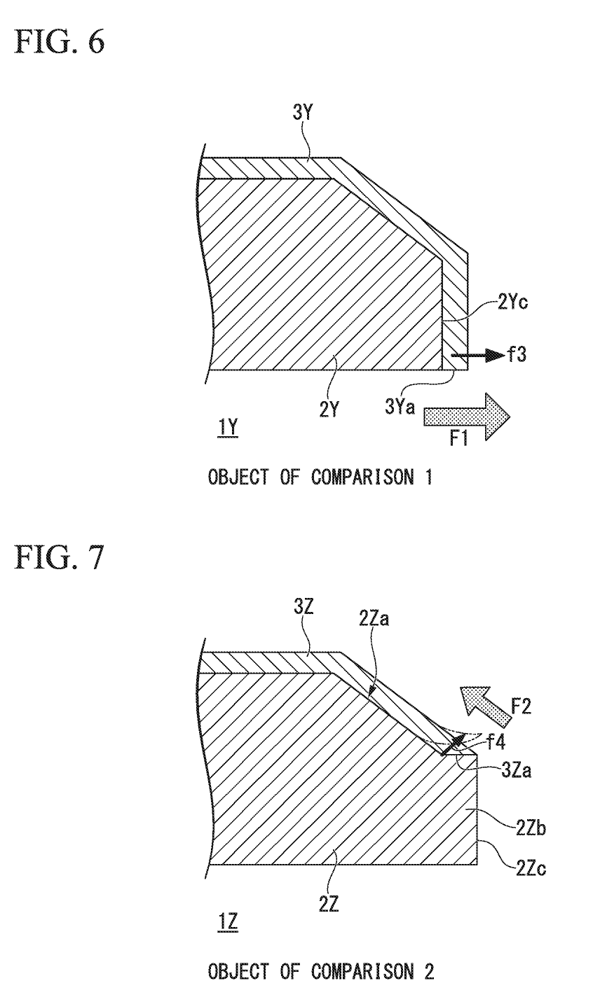

FIG. 5 is a diagram illustrating an example of a state of extracting the electronic card 1. In a case that the electronic card 1 is extracted from the pocket B1, a nail T1 of a finger T of a card user or the like can be hooked on the wall surface 2d of the step 2b, and the electronic card 1 can be easily extracted. According to the electronic card 1, in a case that the electronic card 1 is extracted by pinching it with the finger T, the step 2b can be pinched by a ball T2 of the finger T, and the electronic card can be easily extracted.

Next, a difference between the electronic card 1 of the first embodiment and an electronic card that is an object of comparison will be described. FIG. 6 is a cross-sectional view of an electronic card 1Y according to a comparative example. In the electronic card 1Y illustrated in FIG. 6, the step 2b is not provided in the card casing 2Y as compared with the electronic card 1. Therefore, for example, in a case that the electronic card 1Y is extracted from the pocket B1 by pinching it with the fingers T, a force F1 is applied to the vicinity of the end surface 2Yc of the card casing 2 in the direction in which the electronic card 1Y is extracted.

Then, in the vicinity of the end surface 3Ya of the sheet shaped part 3Y, a force f3 in a direction in which the sheet shaped part 3Y peels off from the card casing 2Y may occur. In the example of FIG. 6, the folded places of the sheet shaped part 3Y are two places, and a force f3 in a direction in which the sheet shaped part 3Y peels off from the card casing 2Y is also generated by the restoring force of the sheet shaped part 3Y returning to a flat shape. Therefore, if the electronic card 1Y is repeatedly extracted from the pocket B1, there is a possibility of the sheet shaped part 3Y being peeled off from the card casing 2Y.

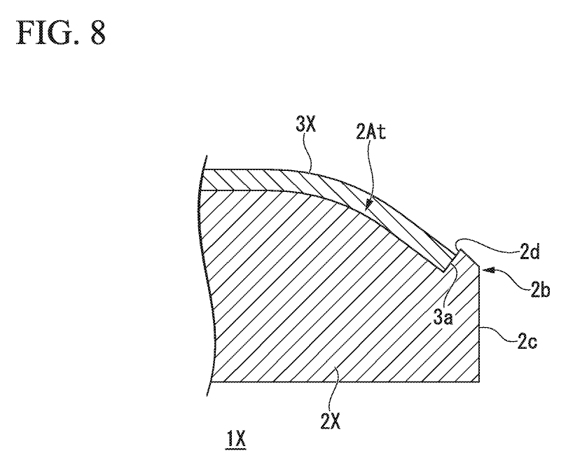

FIG. 7 is a cross-sectional view of an electronic card 1Z that is another object of comparison. In the example of FIG. 7, a step 2Zb is provided on an end surface 2Za of a card casing 2Z. In the example of FIG. 7, the height of the step 2Zb is formed to be the same as the thickness of a sheet shaped part 3Z. For example, in a case that the electronic card 1Z is accommodated in the pocket B1, a force F2 in the direction along the tapered surface 2Za is applied to the vicinity of the end surface 2Zc of the card casing 2Z. Then, a force f4 in a direction in which the sheet shaped part 3Y peels off from the card casing 2Y can occur in the vicinity of the end surface 3Ya of the sheet shaped part 3Y, due to the frictional force between the pocket B1 and the sheet shaped part 3Y. Therefore, in a case that the electronic card 1Z is repeatedly extracted from the pocket B1, there is a possibility of the sheet shaped part 3Z being peeled off from the card casing 2Z.

According to the electronic card 1 of the aforementioned first embodiment, since the step 2b is formed in the card casing 2, peeling of the sheet shaped part 3 is prevented, and since the tapered surface 2At is formed in the card casing 2, the electronic card 1 can be easily accommodated. Furthermore, according to the electronic card 1, since the step 2b is formed in the card casing 2, the electronic card 1 can be easily extracted by the finger T. According to the electronic card 1, in a case that the width of the step 2b is formed to be narrowed to approach the end surface 2c of the card casing 2, it is possible to reduce the design influence of the step 2b on the surface of the sheet shaped part 3 to seamlessly show the sheet shaped part 3 and the card casing 2, and the design of the electronic card 1 can be improved.

### Second Embodiment

In the second embodiment, it is assumed that the tapered surface 2At is formed in a shape other than the linear inclination, instead of being formed with the linear inclination as illustrated in the first embodiment.

In the following description, the same components as those of the first embodiment are denoted by the same reference numerals, and the description of the repeated configuration will be omitted as appropriate.

FIG. 8 is a cross-sectional view of an electronic card 1X according to a modified example. In the card casing 2X of the electronic card 1X, the tapered surface 2At is formed to have a curved cross section so that the inclination gradually changes toward the end surface 2c. By forming the tapered surface 2At with a curved surface, no corner portion is formed on the tapered surface 2At, and the decoration is prevented from being lost on the surface of the sheet shaped part 3 by rubbing the decoration at the corner portion. Therefore, according to the electronic card 1X, the durability of the sheet shaped part 3 can be improved.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An electronic card comprising:
a card casing which is formed as a plate-like body, and in which a tapered surface having an inclination in which a thickness of a cross-section decreases toward an end surface of the plate-like body on one surface side of the plate-like body, and a step protruding from the tapered surface in a direction intersecting the tapered surface is formed;
an electronic device incorporated in the card casing; and
a sheet shaped part in which a thickness of a cross section is formed to be thinner than a height of the step, and end surface abuts against a wall surface formed on the step, and which is fixed to the one surface side of the card casing including the tapered surface.

2. The electronic card according to claim 1, wherein the step is formed to protrude in a direction of a normal line to the tapered surface.

3. The electronic card according to claim 1, wherein the card casing is a card key.
